(19) United States
(12) Patent Application Publication
(10) Pub. No.: US 2012/0027549 A1
(43) Pub. Date: Feb. 2, 2012

(54) Truck bed with tipping platform and lift

(76) Inventor: Larry Alexander, Indianapolis, IN (US)

(21) Appl. No.: 12/804,653

(22) Filed: Jul. 28, 2010

(51) Int. Cl. B60P 1/54; B60P 1/04; B66C 23/36; B60P 1/00; B60P 1/48

(52) U.S. Cl. 414/469; 414/812; 212/294

(57) ABSTRACT

A method of performing landscaping or construction work which utilizes portions of a known lift, crane or hoist unit in a novel way. Angled knuckle portions of the lift are modified to include reinforced eyelets or equivalent structures. A platform is hingedly mounted to the rear of a truck bed and also includes reinforced eyelet structures. Cables are provided between the lift eyelets and the platform eyelets to enable raising and lowering of the platform to conduct loading and unloading operations. A dump box for transporting soil or other products may be utilized in the system and is mounted between upper drive elements of the lift, crane or hoist.

### BACKGROUND AND OBJECTS OF THE INVENTION

The present invention is generally related to the landscaping and/or construction arts and, in particular, includes the use of a special lift or hoist to allow loading in an efficient manner.

Applicant's prior patents in this particular field are U.S. Pat. Nos. 7,717,662 and 7,713,019 issued in Class 414.

It is an object of the invention to demonstrate a particular loading method utilizing the unique structure of a specialized crane or lift.

It is a further object of the invention to show a a crane or lift method of use which may eliminate the need for a trailer in the landscaping and construction arts.

It is a still further object of the invention to set forth a lifting and loading method which may be practiced with or without a dumpbox of a type used in the art.

It is also an object of this disclosure to show a modified crane or lift structure, one which is normally used to load and unload products, which is used in a specialized way to effect the tipping of a platform on the back of a flatbed or pick-up truck.

These and other critical and important objects of the invention will be appreciated by those of skill in the trucking, landscaping, construction and load handling arts.

### PRIOR ART PATENTS AND DESIGNS FROM APPLICANT'S U.S. Pat. Nos. 7,713,019 and 7,717,662

Referring to the drawing figures, FIGS. 1a through 1f show a lift hoist or crane unit 10.

The various components are numbered in FIG. 1c as follows:

a pair of arms 11 and 12 are connected by a cross-arm indicated at numeral 14;
the lower ends of arms 11 and 12 have angled rocker elements 17 and 18;
numerals 21 and 22 indicate lower support and drive elements;
the ends of the drive elements are shown at numerals 23 and 24 as angled to receive the angled upper rocker elements;
a winch unit is shown at numeral 16.

The winch unit 16 is utilized to pick up a load 29 as indicated in FIG. 1f.

As indicated in the progression of FIGS. 1a through 1f, the upper arms 11,12 and the cross member 14 are driven through various angles from zero degrees in FIG. 1a to about 135 degrees in FIG. 1f.

### SUMMARY OF THE INVENTION

The invention sets forth a NEW METHOD OF USE for a lift, crane or hoist used in applicant's prior U.S. Pat. Nos. 7,713,019 and 7,717,662.

Angled knuckle or angled rocker portions, shown at numerals 17 and 18 of FIG. 1c, are used to raise and lower a platform placed at the rear of a flatbed truck or pick-up truck.

The knuckle portions 17 and 18 are part of an overall lift system shown in FIGS. 1a through 1f.

The platform is hinged at the back of the truck bed and moves from a level horizontal position parallel to the ground to a lowered position in contact with the ground allowing the drive-on of a walk-behind or other yard or construction tools.

After tipping back to the level position and locking the load, the driver can proceed to the next job.

The method allows a single type of lift to perform various valuable functions, namely:

raising and lowering of a platform when needed,

loading/unloading cargo without using a platform,

utilizing a soil dump box when needed.

### BRIEF DESCRIPTION OF THE DRAWING FIGURES

FIG. 1 shows a prior art lift or crane in various positions as utilized in applicant's prior patents.

FIG. 2 shows a side schematic view of the principal invention components and illustrates the critical use of a single lift 10 to perform various functions.

FIG. 3 is a side schematic view of lift 10 in a partially elevated position to hold the platform 50 in a horizontal transporting mode.

FIG. 4 is a side schematic view showing the platform 50 in a lowered or tipped position by means of the knuckle element 18 of the lift.

FIG. 5 is a top schematic view showing the eyelets 50E of the platform 50 connected to the knuckle eyelets 17E and 18E via cables 55. The open area between arms 11 and 12 and crossbar 14 is illustrated.

FIGS. 6 and 7 show a dump box 60 as being loaded onto the top portions of the driven elements, i.e. 11, 12 and 14.

FIG. 8 shows a hitch tube or hinge assembly 40 to which the platform 50 is pivotally attached.

FIG. 9 shows the various critical functions performed by the single lift 10, i.e. tipping a rear platform 50, moving a load 29 and carrying a dump box 60.

### FULL DESCRIPTION OF THE PREFERRED EMBODIMENTS

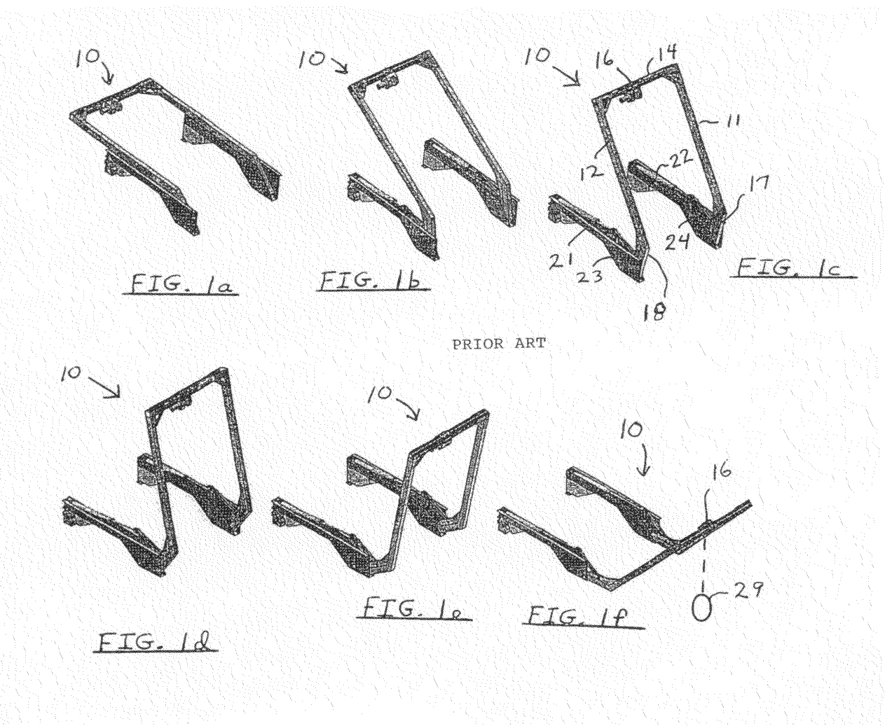

Referring to the drawing figures, FIGS. 1a-1f show a specialized and patented crane which proceeds from a flat at-rest position through various angles to pick-up or deliver a load 29 shown in FIG. 1f.

FIG. 1c indicates lower hydraulic drive means at 21 and 22 and upper drive means at 11 and 12. A crossbar and winch are shown at 14 and 16.

The angled driven elements or KNUCKLES are shown at 17 and 18 and play a critical role in this particular invention to tip a loading platform.

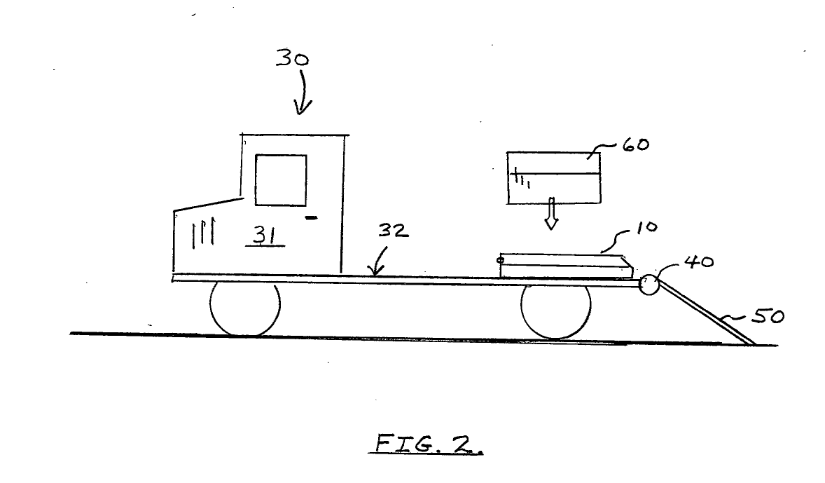

FIG. 2 shows a truck 30 having a forward cab 31 and a rear bed 32.

The major components of the invention are shown in FIG. 2 as follows:

lift or crane 10 which is to be modified and used in the novel method described herein,

hinge 40 and loading platform 50 to be further described,

soil dump box 60 which may be used as needed.

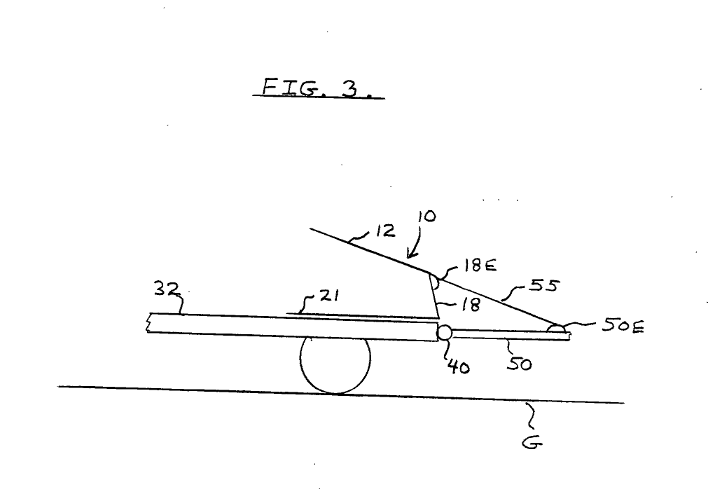

FIG. 3 is a side schematic view of the combined lift 10 and platform 50, with the platform being in a transport-position parallel to the ground G.

In FIG. 3, it is to be understood that the lift 10 is in a slightly elevated position as shown in FIG. 1b

The lift has an angled knuckle portion 18 with a reinforced eyelet 18E formed thereon.

Arm 12 extends from the angled knuckle 18 and a lower drive element 21 pushes or pulls on the knuckle 18 as needed.

FIG. 3 further shows the platform 50 being hingedly mounted to the rear of the truck bed 32 by means hinge element 40.

The rear portion of platform 50 has a reinforced eyelet 50E formed thereon.

As further shown, a cable 55 extends between the eyelets 18E and 50E. Such cable enables the platform 50 to move as the knuckle element 18 is pivoted to the left or right at the option of an operator.

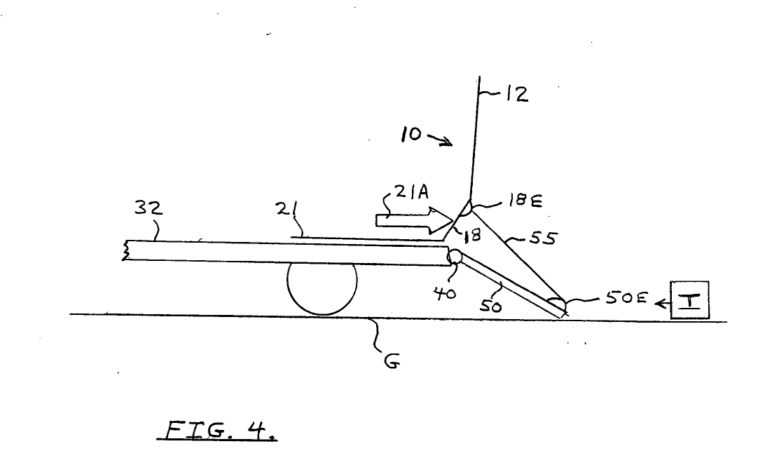

From the horizontal platform position of FIG. 3, the platform 50 is lowered to an angled position in contact with ground G as shown in FIG. 4.

In FIG. 4, the lift 10 has been pivoted to the right under the action of the lower drive system as indicated by arrow 21A.

The position of the lift 10 and angled knuckle element 18 corresponds roughly to that shown in FIG. 1d or 1e in this specification.

Once the platform 50 has been lowered to the ground position of FIG. 4, a construction or landscaping tool T can be driven or pushed onto the truck bed 32.

Subsequently, via the reverse motion of arrow 21A, the knuckle 18 and attached platform 50 are pivoted until the platform is again in the horizontal position of FIG. 3.

Once the tool or other load T is locked in place, a driver can proceed to the next job or location.

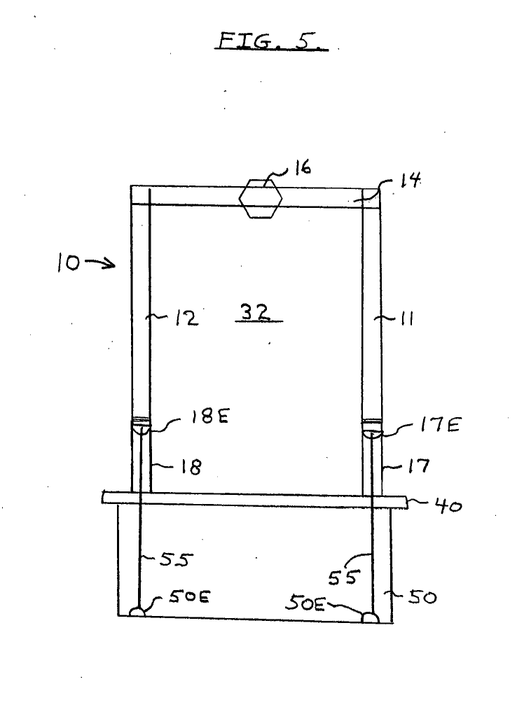

FIG. 5 is a top schematic view of portions of the lift 10 in relation to the platform 50 and cables 55.

As shown, the left angled knuckle element 18 has a reinforced eyelet 18E formed thereon. The right angled knuckle element 17 has a reinforced eyelet 17E formed thereon.

As also shown in FIG. 5, the platform 50 has a pair of reinforced eyelets 50E located at a rear portion thereof.

Cable elements 55 extend between the respective eyelets of knuckles 18 and 17 and the eyelets 50E formed on the rear of platform 50.

Also shown schematically in FIG. 5 are the lift arms 11 and 12 extending from the angled knuckle elements 17 and 18 respectively. Such construction is indicated in FIG. 1c.

The cross-arm 14 and winch 16 are also indicated schematically in FIG. 5.

As further indicated in the schematic view of FIG. 5, there is provided an open area between the arms 11, 12 and 14 so that the truck bed 32 can be seen.

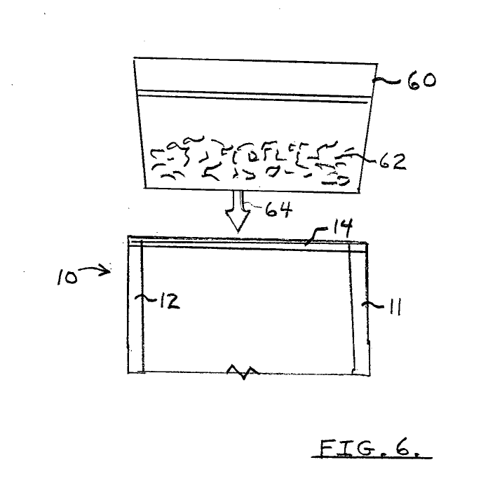

Such open area can be utilized to support a dump box 60 which is shown schematically in FIG. 6 as carrying a load of top soil 62.

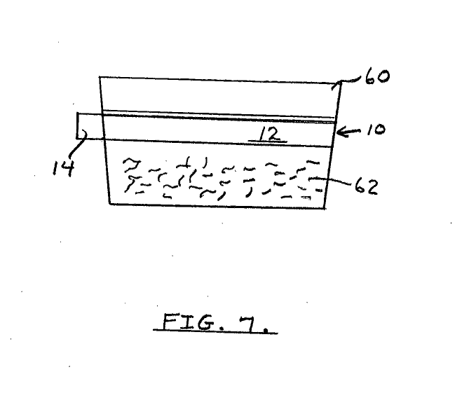

As indicated by the arrow 64 in FIG. 6, the dump box is lowered into the open area and finally rests on the top portions of the lift 10 to be used as part of a landscaping or construction job as needed from the position shown in FIG. 7.

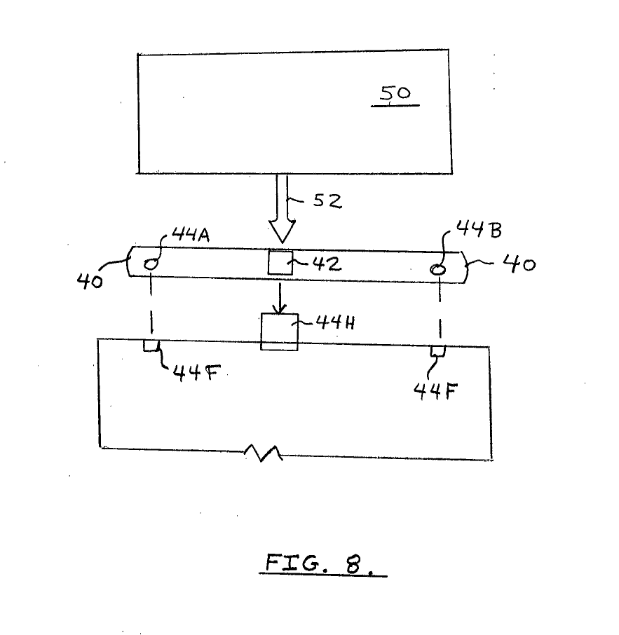

Referring to FIG. 8, an elongated cylindrical hitch tube 40 is shown. The flat pivoting platform 50 is hingedly attached to the hitch tube as indicated schematically by arrow 52.

The hitch tube 40 has a central aperture portion 42 for attachment to a truck hitch indicated generally at numeral 44H. The hitch tube 40 further has apertures 44A and 44B formed therein to provide attachment means with relation to truck frame portions indicated at 44F.

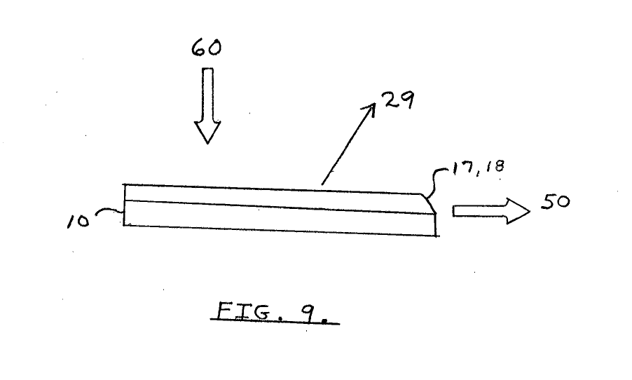

Reference is now made to FIG. 9.

It is thus to be appreciated that one of the critical features of the invention is that the lift 10 can be utilized in three different ways, namely,

to perform a product lifting and loading function as indicated by numeral 29 in FIG. 1f,

to drive a load platform 50 via the knuckle elements 17 and 18 formed on the lift 10,

to carry and use a dump box 60 when needed for a particular operation. See schematic FIG. 9.

Such multiple-function capabilities for a single lift, crane or hoist is a breakthrough and highly useful for marketing of lift structures in the art.

While a particular method of use and system have been shown and described herein, it is intended in this specification to included all related methods and systems which would reasonably occur to those of skill in the art.

The invention is further defined by the claims appended hereto.

1-7. (canceled)

8. A method of conducting construction or landscaping operations comprising the steps of:
a) providing a truck having a truck bed with a lift or crane mounted on a rear portion thereof,
b) providing that said lift includes two lower drive elements mounted fixedly to said truck bed,
c) providing that said lift includes two upper driven elements having a bar connecting the upper portions thereof with a winch mounted on said bar,
d) providing a pair of angled knuckles or angled rockers between each of said upper driven elements and said lower drive elements,
e) providing a reinforced eyelet mounted on each of said angled knuckles,
f) providing a platform mounted on the rear of the truck bed by means of a hinge assembly,
g) providing a pair of reinforced eyelets mounted on a rear portion of said platform,
h) providing that a pair of cables extend between the eyelets on the angled knuckles or angled rockers of the lift and the eyelets formed on the rear of the platform,
i) lowering the rear portion of the platform to touch ground level,
j) loading a construction or landscaping tool onto the truck bed and locking the tool into a secure position,
k) raising the rear of the platform to a level parallel to ground level,
l) providing a dump box means for transporting soil and other landscaping or construction items to or from a job site.

8. A method of conducting construction or landscaping operations comprising the steps of:
a) providing a truck having a truck bed with a lift or crane mounted on a rear portion thereof,
b) providing that said lift includes two lower drive elements mounted fixedly to said truck bed,
c) providing that said lift includes two upper driven elements having a bar connecting the upper portions thereof with a winch mounted on said bar,
d) providing a pair of angled knuckles or angled rockers between each of said upper driven elements and said lower drive elements,
e) providing a reinforced eyelet mounted on each of said angled knuckles,
f) providing a platform mounted on the rear of the truck bed by means of a hinge assembly,
g) providing a pair of reinforced eyelets mounted on a rear portion of said platform,
h) providing that a pair of cables extend between the eyelets on the angled knuckles or angled rockers of the lift and the eyelets formed on the rear of the platform,
i) lowering the rear portion of the platform to touch ground level,
j) loading a construction or landscaping tool onto the truck bed and locking the tool into a secure position,
k) raising the rear of the platform to a level parallel to ground level,
l) providing a dump box means for transporting soil and other landscaping or construction items to or from a job site.
